(19) United States
(12) Patent Application Publication
(10) Pub. No.: US 2008/0163326 A1
(43) Pub. Date: Jul. 3, 2008

(54) Portable Video Hard-Disk Drive (pVHDD) System

(76) Inventor: Guobiao ZHANG, Carson City, NV (US)

Correspondence Address: GUOBIAO ZHANG, P.O. BOX 6182, STATELINE, NV, 89449-6182, US

(21) Appl. No.: 11/736,747

(22) Filed: Apr. 18, 2007

(30) Foreign Application Priority Data
Dec. 8, 2006 (CN) 200610022445.5
Dec. 8, 2006 (CN) 200610022447.4

(51) Int. Cl. H04N 7/173; H04N 7/18; H04N 7/16

(52) U.S. Cl. 725/134; 725/75; 725/132; 725/112; 725/113; 725/86; 725/87; 725/81; 725/62

(57) ABSTRACT

Pre-recorded video library (PVL) is much more difficult to realize than other pre-recorded multimedia library (PML). Among the existing, mature mobile mass storages, portable HDD (with 1″<disk diameter<3.5″) is the only one that can store a PVL. Accordingly, the present invention discloses a portable video hard-disk drive (pVHDD). It should be removable from the mobile video device.

### CROSS-REFERENCE TO RELATED APPLICATIONS

This application is related to China, P.R. Patent Application 200610022447.4, “Portable Video Hard-Disk Drive and Playback System”, filed Dec. 8, 2006 and China, P.R. Patent Application 200610022445.5, “User-Configurable Pre-Recorded Storage with Strong Copyright Protection”, filed Dec. 8, 2006.

### BACKGROUND

1. Technical Field of the Invention

The present invention relates to the field of electronic system, and more particularly to hard-disk drive (HDD).

2. Related Arts

Consumers desire to access as much multimedia contents as possible while on the go. To satisfy this desire, various multimedia-distribution models have been disclosed. One model is the “download” model, i.e. multimedia contents are wirelessly downloaded by a mobile user from the internet. However, at present or in the near future, fast, pervasive and reliable wireless internet access is not readily available. This makes multimedia download, particularly movie download, difficult. Another model is the “pre-recorded” model, i.e. pre-recorded multimedia library (PML) has been recorded in a mobile mass storage (i.e. mass storage used in a mobile device) before it is distributed to a user. Here, the word “LIBRARY” means that the mobile mass storage contains not just a small quantity of multimedia contents, but a quantity large enough so that a user can access as much multimedia contents as possible anytime anywhere.

Multimedia contents could be textual (e.g. books), audio (e.g. songs), image (e.g. GPS maps, photos), video (e.g. movies) and others. Accordingly, PML can be categorized into pre-recorded textual library (PTL), pre-recorded audio library (PAL), pre-recorded image library (PIL) and pre-recorded video library (PVL). Because movies take much larger space (˜500 MB/movie) than books (˜0.5 MB/book), songs (˜4 MB/song) or photos (˜3 MB/photo), PVL is much more difficult to realize than other PML's. To overcome this and other difficulties, the present invention discloses a portable video hard-disk drive (pVHDD).

### OBJECTS AND ADVANTAGES

It is a principle object of the present invention to satisfy the mobile user's desire to access as much videos as possible anytime anywhere.

It is a further object of the present invention to protect both interests of consumers and copyright owners.

It is a further object of the present invention to lower the entry barrier for pre-recorded video library.

It is a further object of the present invention to provide stronger copyright protection to contents.

In accordance with these and other objects of the present invention, the present invention discloses a portable video hard-disk drive (pVHDD).

### SUMMARY OF THE INVENTION

The present invention follows a “pre-recorded” model to distribute videos. Because each movie occupies 500MB, a pre-recorded video library (PVL) containing even 100 movies requires ˜50 GB space. This places stringent requirements on the storage capacity of the mobile mass storage (i.e. mass storage used in a mobile device). Among all existing, mature mobile mass storages (Table 1), portable HDD (with 1″<disk diameter<3.5″, e.g. 1.8″ or 2.5″ HDD) is the only one that can store a PVL. Accordingly, the present invention discloses a portable video hard-disk drive (pVHDD), which is a portable HDD containing a pre-recorded video library (PVL).

Movielink (http://www.movielink.com) is an exemplary movie library. FIG. 2 (Table 2) lists the number of movies in several genres at Movielink. It contains 1888 movies in total, which requires ˜1 TB space. At present or in the near future, the storage capacity of a single pVHDD is not large enough to meet this requirement (Table 1). Accordingly, the preferred pVHDD should be removable from the mobile video device. If the desired content is not in a first pVHDD, the user can pull it out and insert a second pVHDD. This differs significantly from prior arts, where HDD is integrated into the mobile video device.

Because a PVL contains a large amount of copyrighted videos, if full access is granted at the moment of distribution, a user will be charged a hefty upfront fee for the copyrights of all videos therein. Apparently, the user is not willing to pay copyright fees for the videos he is not interested in. To protect both interests of consumers and copyright owners, access to the PVL should be controlled in such a way that a user only pays when he accesses.

With access control, hardware (e.g. pVHDD) cost can be distributed through access fees and therefore, a user can obtain the hardware at a nominal price. This will lower the entry barrier for the pVHDD. To further lower the entry barrier, pVHDD can also contain advertisements. A user will be charged a reduced access fee if advertisement playback is accepted during video playback.

In prior arts, movies (or other contents) are distributed in optical discs, e.g. DVD. For optical discs, contents are “mechanically written” by imprinting a master onto disc blanks. Within one batch, all DVD's are imprinted by a same master. Hence, content data cannot be varied, and all DVD's will have the same data (or use the same encryption key) for a same content. Once the encryption for one DVD is broken, the copyright protection for all DVD's in this batch will be broken.

To provide stronger copyright protection to contents, the present invention discloses an individual—encryption method. It is suitable for read-write storage whose contents are “electrically written”. Examples include HDD and flash memory. Here, HDD will be used as an example to explain this method. Within one batch of HDD's, contents come from a same source. Because they are electrically written, content data can be easily varied during the writing process. For a same content, different HDD's in a same batch could have different data (or use different encryption keys). Even if the encryption for one HDD is broken, the copyright protection for other HDD's in this batch is still intact. To provide even stronger copyright protection, different contents on a same HDD may use different encryption keys.

### BRIEF DESCRIPTION OF THE DRAWINGS

FIG. 1 (Table 1) compares the storage capacity of several existing, mature mobile mass storages;

FIG. 2 (Table 2) lists the number of movies in several genres at Movielink (http://www.movielink.com) and their storage requirements;

FIG. 3 illustrates a preferred pVHDD system;

FIG. 4 is a simplified block diagram of the preferred pVHDD system;

FIG. 5 illustrates a preferred access method;

FIG. 6A illustrates a preferred payment process; FIG. 6B illustrates a preferred playback process;

FIG. 7 illustrates a preferred sequence to select accessibility;

FIG. 8 illustrates a preferred user interface to select accessibility;

FIG. 9 is a block diagram of a preferred access-control block;

FIG. 10 is a simplified block diagram of a preferred pVHDD system containing multi-sourced video library;

FIG. 11 is a simplified block diagram of a preferred pVHDD system containing advertisements (pVHDD+AD);

FIGS. 12A-12B illustrate two preferred access methods for the preferred pVHDD+AD;

FIG. 13 illustrates a preferred user-configurable access method for the preferred pVHDD+AD;

FIG. 14 illustrates several more functions of a preferred access-control block for the preferred pVHDD+AD;

FIG. 15 illustrates a preferred hybrid display for contents and advertisements;

FIG. 16 is a simplified block diagram of a preferred pVHDD system containing multi-sourced video library and advertisements;

FIG. 17 illustrates content encryption within a same batch in prior arts;

FIG. 18 illustrates content encryption within a same batch in the present invention.

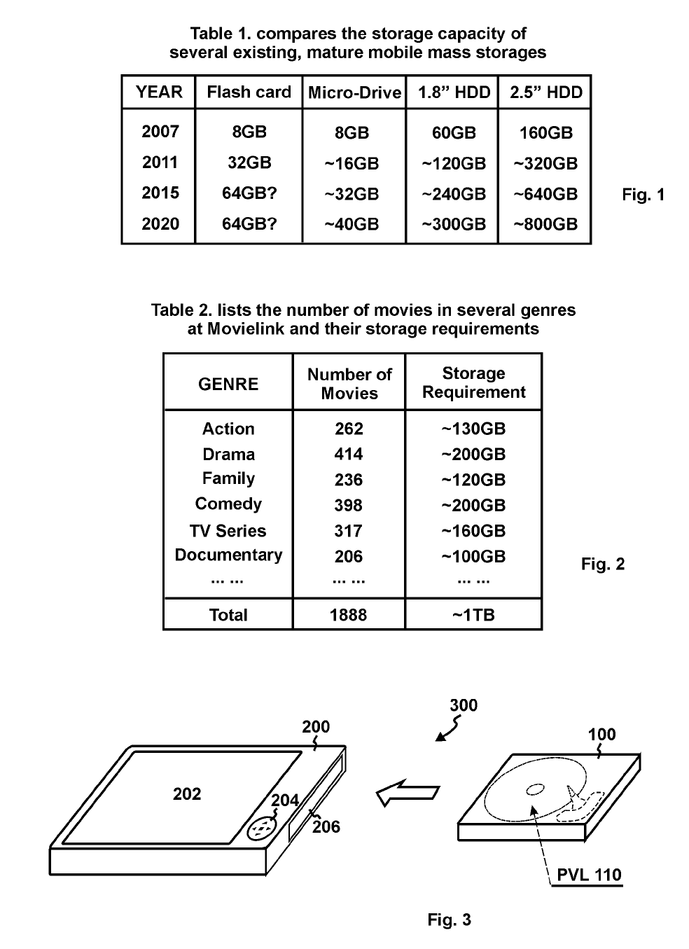

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The present invention follows a “pre-recorded” model to distribute videos. Because each movie occupies ˜500 MB, a pre-recorded video library (PVL) containing even 100 movies requires ˜50 GB space. This places stringent requirements on the storage capacity of the mobile mass storage (i.e. mass storage used in a mobile device). Among all existing, mature mobile mass storages (Table 1), portable HDD (with 1″<disk diameter>13.5″, e.g. 1.8″ or 2.5″ HDD) is the only one that can store a PVL. Accordingly, the present invention discloses a portable video hard-disk drive (pVHDD), which is a portable HDD containing a pre-recorded video library (PVL).

Movielink (http://www.movielink.com) is an exemplary movie library. FIG. 2 (Table 2) lists the number of movies in several genres at Movielink. It contains 1888 movies in total, which requires ˜1 TB space. At present or in the near future, the storage capacity of a single pVHDD is not large enough to meet this requirement (Table 1). Accordingly, the preferred pVHDD should be removable from the mobile video device. If the desired content is not in a first pVHDD, the user can pull it out and insert a second pVHDD. This differs significantly from prior arts, where HDD is integrated into the mobile video device.

FIG. 3 illustrates a preferred mobile video playback system associated with the pVHDD, or pVHDD system 300. It comprises a pVHDD 100 and a mobile video device 200. The pVHDD 100 contains a pre-recorded video library (PVL) 110. It has a disk diameter between 1″ and 3.5″ (e.g. 1.8″ or 2.5″ HDD) and preferably a storage capacity of at least 50 GB, which can store ˜100 movies. The mobile video device 200 comprises a display 202, input 204, and slot 206. It plays back selected videos from the PVL 110. A preferred mobile video device 200 is cellular phone. The pVHDD 100 is removable from the mobile video device 200. If the desired content is not in a first pVHDD, the user can pull it out and insert a second pVHDD.

Because a PVL 110 contains a large amount of copyrighted videos, if full access is granted at the moment of purchase, a user will be charged a hefty upfront fee for the copyrights of all videos therein. Apparently, the user is not willing to pay copyright fees for the videos he is not interested in. To protect both interests of consumers and copyright owners, access to the PVL 110 should be controlled in such a way that a user only pays when he accesses.

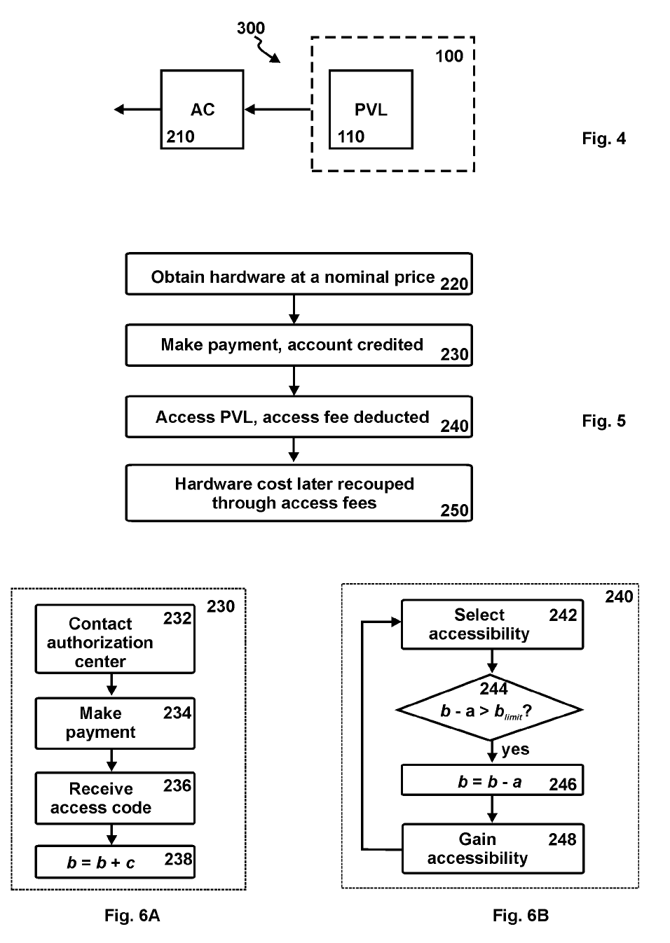

FIG. 4 is a simplified block diagram of the preferred pVHDD system 300. It comprises a pVHDD 100 and an access-control block (AC) 210. The AC 210 controls access to the PVL 110 in the pVHDD 100. To protect copyright, content data are preferably encrypted. The pVHDD system 300 keeps track of an account balance (b), which records credit from payment and debit from usage. The AC 210 can be physically located in the mobile video device 200, or in the pVHDD 100. Another possibility is that a portion of AC 210 is physically located in the mobile video device 200, with the remaining portion located in the pVHDD 100.

FIG. 5 illustrates a preferred access method. It comprises a payment process 230 and a playback process 240. During the payment process 230, a user makes payment and his account is credited. During the playback process 240, the user accesses selected contents in the PVL 110 and corresponding access fees are deducted from his account. Because access fees include not only the copyright fees, but also a portion of the hardware cost, the user could pay a nominal price for the pVHDD 100 (step 220), and the hardware cost can later be recouped from access fees (step 250). This can lower the entry barrier for the PVL 110.

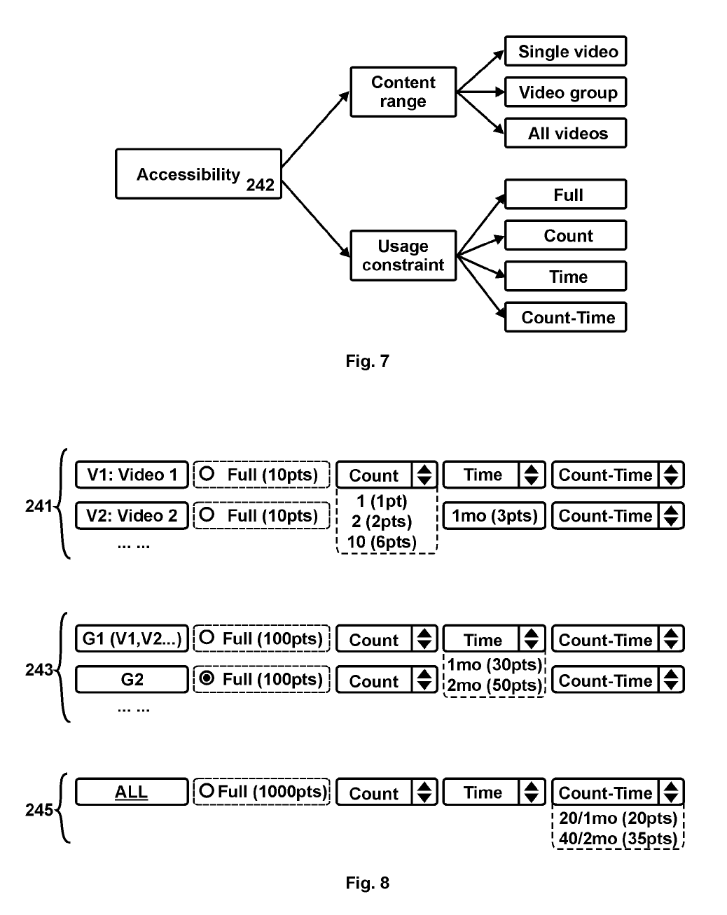

FIG. 6A illustrates a preferred payment process 230. At first, the user contacts an authorization center (step 232). After the user makes payment (step 234), the authorization center issues an access code (step 236), which results in an addition of the credit (c) to the account balance, i.e. b=b+c (step 238).

FIG. 6B illustrates a preferred playback process 240. At first, the user selects the desired accessibility (step 242). Then the remaining balance will be calculated, which is the difference between the existing balance and the access fee (a). As long as the remaining balance is above a threshold bₗᵢₘᵢₜ (step 244), the user can obtain the desired accessibility (step 248) and the corresponding access fee is deducted from the account balance, i.e. b=b−a (step 246). Note that payment process 230 can occur before the playback process 240 (like a pre-paid phone card, or debit card), or after the playback process 240 (like a credit card).

In FIGS. 5-6B, the account balance b is stored in the pVHDD system 300. Only during the payment process 230, does the pVHDD system 300 need to contact the authorization center. Because the authorization center is located remotely, this contact process needs to be carried out by a telecommunication means, such as telephone (landline or cellular) or internet (wired or wireless). During the playback process 240, the pVHDD system 300 can determine a user's accessibility on its own and does not need to rely on any telecommunication means. Because the payment process 230 only occurs occasionally (e.g. monthly), the preferred pVHDD system 300 work almost all time even in areas where no telecommunication means is available.

To facilitate the payment process 230, the mobile video device 200 in the pVHDD system 300 preferably uses a cellular phone. Cellular phone provides several advantages: 1) cellular communication has the widest coverage; 2) a user does not need to punch in numbers for device ID and credit card, because device ID can be directly transmitted from the cellular phone to the authorization center and payment can be directly deducted from the cellular account.

FIG. 7 illustrates a preferred sequence to select accessibility (step 242). It comprises two steps: the first step is to select content range; the second step is to select usage constraint. The content range could be a single video, a video group or all videos in the PVL 110; the usage constraint could be full-access (i.e. unlimited playback), count-limited (i.e. the number of playbacks not to exceed a limit), time-limited (i.e. playback must occur within a specified period), count-time-limited (i.e. the number of playbacks within a period not to exceed a limit).

FIG. 8 illustrates a preferred user interface to select accessibility. It comprises three sections 241, 243, 245. They correspond to single video, video group or all videos, respectively. For example, in section 241, a user selects the usage constraint for video V1. When he clicks “Count”, a pull-down menu displays three choices: “1 (1 pt)”, “2 (2 pts)”, “10 (6 pts)”, which means if the user selects to view video V1 once, the access fee is 1 point; to view V1 twice, the access fee is 2 points; to view V1 for ten times, the access fee is 6 points.

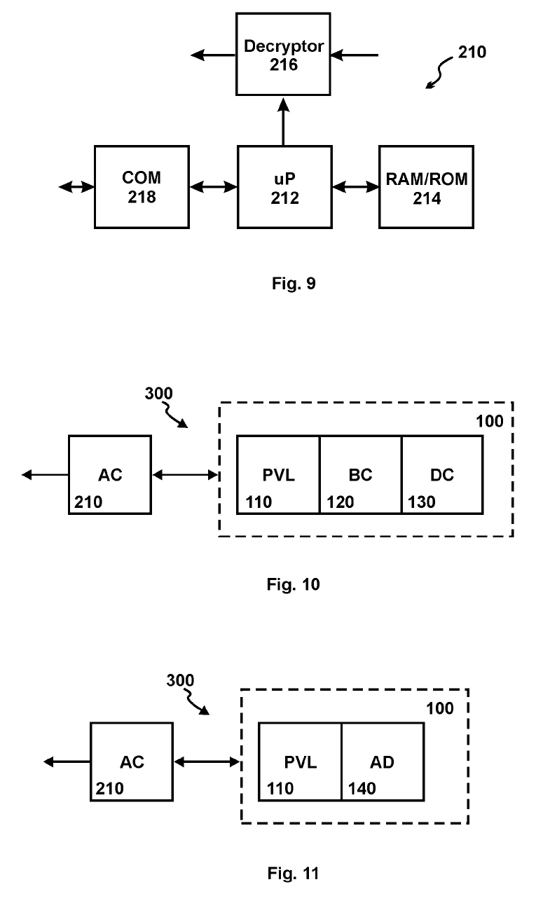

FIG. 9 is a block diagram of a preferred access-control block (AC) 210. It comprises micro-processor 212, memory (including RAM and ROM) 214, decryptor 216 and communication means (COM) 218. ROM 214 stores information such as device ID, account balance, access fees and encryption keys. Some of these information can also be stored in the pVHDD 100. Micro-processor 212 determines whether a user is allowed to access a video. If allowed, the corresponding encryption key will be sent to the decryptor 216. The COM 218 provides information exchange between the pVHDD system 300 and the authorization center. It could be telephone (landline or cellular), internet (wired or wireless) or others.

FIG. 10 is a simplified block diagram of a preferred pVHDD system containing multi-sourced video library 300. Its contents come from various sources. To be more specific, besides PVL 110, the pVHDD 100 further contains broadcast contents (BC) 120 and/or downloaded contents (DC) 130. The BC 120 are delivered by broadcast means, e.g. radio signals, TV signals, wireless internet, cellular phone, wired internet or others. They typically comprise latest released movies, songs or books. The DC 130 are downloaded by user, e.g. from internet. They can be tailored to suit a user's individual needs.

The pVHDD system containing multi-sourced contents 300 can be easily implemented in a multimedia cellular phone. The multimedia cellular phone uses pVHDD 100 to access PVL 110, while using cellular communication to get the recent release. The cellular communication can also carry out the payment process 230 for the PVL 110. The multimedia cellular phone combines both strengths of the “download” and “pre-recorded” models for multimedia distribution and therefore, will be a most preferred pVHDD system in the future.

With access control, hardware (e.g. pVHDD) cost can be distributed through access fees and therefore, a user can obtain the hardware at a nominal price. This will lower the entry barrier for the pVHDD. To further lower the entry barrier, pVHDD can also contain advertisements. A user will be charged a reduced access fee if advertisement playback is accepted during video playback.

FIG. 11 is simplified a block diagram of a preferred pVHDD system 300 containing advertisements (pVHDD+AD). Besides PVL 110, the pVHDD 100 also contains advertisements (AD) 140. This preferred pVHDD system 300 further comprises an access-control block (AC) 210, which controls access to PVL 110 and AD 140.

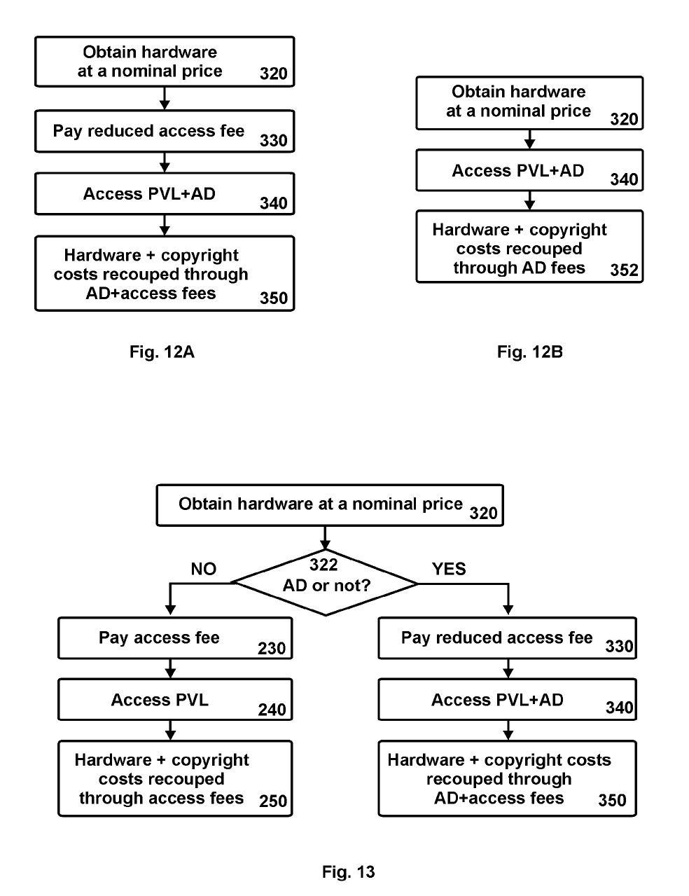

FIGS. 12A-12B illustrate two preferred access methods for the preferred pVHDD+AD 300. In FIG. 12A, the user first obtains hardware at a nominal price (step 320). During usage, the user pays reduced access fees (step 330) and advertisements are played with selected contents (step 340). The hardware and copyright costs are recouped through both advertisement and access fees (step 350). In FIG. 12B, enough advertisements are played with selected contents so that the user does not need to pay access fee (step 340). The hardware and copyright costs are recouped through the advertisement fees (step 352).

FIG. 13 illustrates a preferred user-configurable access method for the preferred pVHDD+AD 300. Before usage, a user is inquired about “advertisement or not?” (step 322). If the answer is “YES”, the user pays the reduced access fee (step 330); advertisements are played with contents (step 340); and the hardware and copyright costs are recouped through both advertisement and access fees (step 350). Apparently, as in FIG. 12B, enough advertisements can be played so that the user does not have to pay access fee. If the answer is “NO”, the user pays the full access fee (step 230); no advertisements are to be played (step 240); and the hardware and copyright costs are recouped through access fees (step 250).

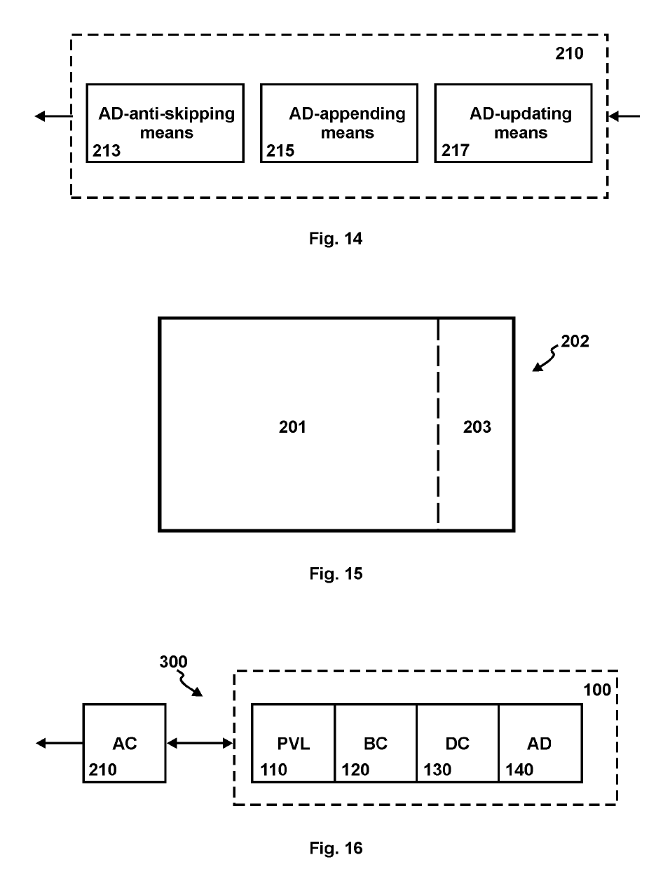

In the preferred embodiment of FIG. 14, the AC 210 could further comprise an ad-anti-skipping means 213, an ad-appending means 215, and/or an ad-updating means 217. The ad-anti-skipping means 213 ensures that the selected advertisement is played in full, e.g. cannot be skipped by fast-forwarding. The ad-appending means 215 selects an advertisement based on advertiser's request (e.g. advertiser may request to append his advertisement to a specific genre of movies) and appends it to the video under-play. The ad-updating means 217 updates advertisements periodically. Ad-updating can be delivered by broadcast means, e.g. radio signals, TV signals, wireless internet, cellular phone, wired internet or others. It typically occurs around mid-night, or at times when channel usage is not busy. With ad-updating, more advertisers can be accommodated, local advertisements can be delivered, and advertisements can be kept current.

Referring now to FIG. 15, a preferred hybrid display 202 is disclosed. It comprises two windows 201, 203. Selected video from the PVL is displayed in window 201, while advertisement is displayed in window 203. Contrary to the conventional method where advertisements are played between video segments, they can be played at the same time as selected videos. As a result, more advertisers can be accommodated and more advertisement revenue can be generated. This, in turn, will further reduce the access fees.

FIG. 16 is a simplified block diagram of a preferred pVHDD system 300 containing multi-sourced video library and advertisements. Similar to FIG. 10, the pVHDD 100 contains PVL 110, broadcast contents (BC) 120, downloaded contents (DC) 130 and advertisements (AD) 140. The access-control block (AC) 210 controls access to PVL 110, BC 120, DC 130 and AD 140. The AD 140 can be played not only with PVL 110, but also with BC 120 and DC 130. This result in a reduced access fee for BC 120 and DC 130.

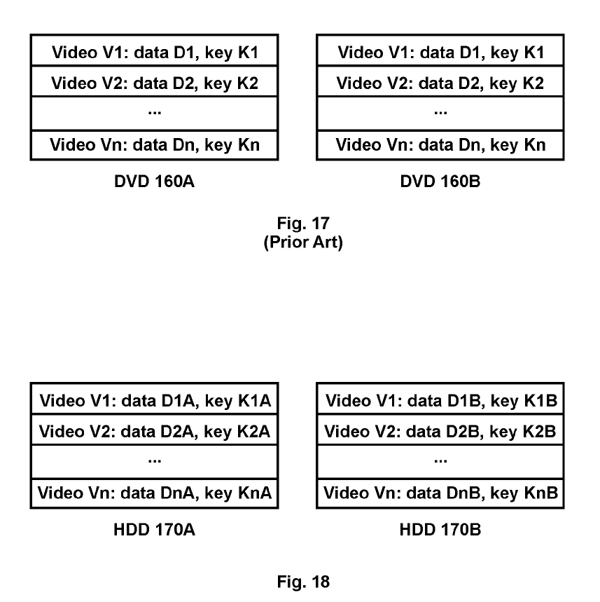

FIG. 17 illustrates content encryption within a same batch in prior arts. In prior arts, movies (or other contents) are distributed in optical discs, e.g. DVD. For optical discs, contents (e.g. videos V1, V2 . . . Vn) are “mechanically written” by imprinting a master onto disc blanks. Within one batch, all DVD's (e.g. 160A, 160B) are imprinted by a same master. Hence, content data cannot be varied and for a same content (e.g. video V1), all DVD's (e.g. 160A, 160B) will have the same data (e.g. D1) or use the same encryption key (e.g. K1). Once the encryption for one DVD (e.g. 160A) is broken, the copyright protection for all DVD's in this batch (including 160A, 160B) will be broken.

To provide stronger copyright protection to contents, the present invention discloses an individual-encryption method. It is suitable for read-write storage whose contents are “electrically written”. Examples include HDD and flash memory. Here, HDD will be used as an example to explain this method. As illustrated in FIG. 18, within one batch of HDD's, contents come from a same source. Because they are electrically written, content data can be easily varied during the writing process. For a same content (e.g. video V1), different HDD's in a same batch (e.g. 170A, 170B) could have different data (e.g. D1A for HDD 170A, D1B for HDD 170B) or use different encryption keys (e.g. K1A for HDD 170A, K1B for HDD 170B; and K1A≠K1B). Even if the encryption for one HDD (e.g. 170A) is broken, the copyright protection for other HDD's in this batch (e.g. 170B) is still intact. To provide even stronger copyright protection, different contents (e.g. videos V1 and V2) on a same HDD (e.g. 170A) may use different encryption keys (e.g. K1A and K2A; and K1A≠K2A).

While illustrative embodiments have been shown and described, it would be apparent to those skilled in the art that may more modifications than that have been mentioned above are possible without departing from the inventive concepts set forth therein. For example, besides containing a pre-recorded video library (PVL), pVHDD can also contain other pre-recorded multimedia library, e.g. pre-recorded textual library (PTL), pre-recorded audio library (PAL) and/or pre-recorded image library (PIL). The invention, therefore, is not to be limited except in the spirit of the appended claims.

What is claimed is:

1. A portable video hard-disk drive (pVHDD) system, comprising:
a portable hard-disk drive with disk diameter between 1″ and 3.5″, said portable hard-disk drive containing a pre-recorded video library (PVL);
an access-control block for controlling access to said PVL; and
a mobile video device for playing back selected videos from said PVL;
wherein said pVHDD is removable from said mobile video device.

2. The pVHDD system according to claim 1, wherein said pVHDD comprises a 1.8″ HDD or a 2.5″ HDD.

3. The pVHDD system according to claim 1, wherein said PVL contains at least 100 movies.

4. The pVHDD system according to claim 1, wherein said mobile video device is a cellular phone.

5. The pVHDD system according to claim 1, further keeping track of an account balance.

6. The pVHDD system according to claim 5, wherein a credit is added to said account balance after a user makes payment.

7. The pVHDD system according to claim 5, wherein an access fee is deducted from said account balance after a user selects desired accessibility.

8. The pVHDD system according to claim 1, wherein a user initially obtains said pVHDD at a nominal price and later pays an access fee to access selected videos in said PVL.

9. The pVHDD system according to claim 8, wherein at least a portion of the hardware cost is recouped through said access fee.

10. The pVHDD system according to claim 1, further containing broadcast contents and/or downloaded contents.

11. The pVHDD system according to claim 1, further containing a pre-recorded textual library, a pre-recorded audio library and/or a pre-recorded image library.

12. The pVHDD system according to claim 1, further containing advertisements.

13. The pVHDD system according to claim 12, wherein said access-control block further comprises an ad-anti-skipping means, an ad-appending means, and/or an ad-updating means.

14. The pVHDD system according to claim 12, wherein a user pays reduced access fee when advertisement playback is allowed during content playback.

15. The pVHDD system according to claim 14, wherein a user pays no access fee when enough advertisements are played during content playback.

16. The pVHDD system according to claim 12, further comprising a hybrid display, said hybrid display further comprising:
a first window for displaying selected videos; and
a second window for displaying advertisements.

17. A batch of read-write storages containing contents from a same source, comprising:
a first read-write storage containing a first data for a first content, said first data being electrically written into said first read-write storage;
a second read-write storage containing a second data for said first content, said second data being electrically written into said second read-write storage;
wherein said first and second data are different.

18. The batch of read-write storages according to claim 17, wherein said first and second data use different encryption keys.

19. The batch of read-write storages according to claim 17, wherein said first read-write storage further contains a third data for a second content, said first and third data using different encryption keys.

20. The batch of read-write storages according to claim 17, wherein said read-write storage is a hard-disk drive or a flash memory.
